(19) United States
(12) Patent Application Publication
(10) Pub. No.: US 2011/0165468 A1
(43) Pub. Date: Jul. 7, 2011

(54) PROCESS FOR PREPARING A SILICON/CARBON COMPOSITE MATERIAL, MATERIAL THUS PREPARED AND ELECTRODE NOTABLY NEGATIVE ELECTRODE COMPRISING THIS MATERIAL

(75) Inventors: Mélanie Alias, Poligny (FR); Frédéric Le Cras, Notre-Dame-de-I'Osier (FR)

(73) Assignee: Commissariat a l' energie atomique et aux energies alternatives, Paris (FR)

(21) Appl. No.: 13/061,939

(22) PCT Filed: Sep. 10, 2009
(86) PCT No.: PCT/EP2009/061772

§ 371 Date: Mar. 2, 2011

(30) Foreign Application Priority Data
Sep. 12, 2008 (FR) 0856158

(51) Int. Cl. H01M 4/583; B05D 1/02; B05D 3/00; B05D 5/00; B05D 3/02

(52) U.S. Cl. 429/231.8; 427/215

(57) ABSTRACT

Process for preparing composite silicon/carbon material composed of carbon-coated silicon particles, wherein the following successive steps are carried out: silicon particles are mixed with a solution of an oxygen-free polymer in a solvent, whereby a dispersion of silicon particles in the polymer solution is obtained; the dispersion obtained in step a) is subjected to a spray-drying operation whereby a composite silicon/polymer material consisting of silicon particles coated with the polymer is obtained; the material obtained in step a) is pyrolyzed whereby the composite silicon/carbon material composed of carbon-coated silicon particles is obtained.

### TECHNICAL FIELD

The invention concerns a process for preparing a silicon/carbon composite material.

The invention further concerns the silicon/carbon composite material obtainable by this process.

In particular, the invention pertains to a silicon/carbon composite material intended to be used as an electrochemically active material for an electrode, especially for a negative electrode, in electrochemical systems with non-aqueous, organic, electrolyte, such as rechargeable electrochemical storage batteries (accumulators) (secondary batteries) with an organic electrolyte, especially in lithium batteries and more precisely in lithium ion batteries.

The invention is also related to an electrode, notably a negative electrode, comprising this composite material as electrochemically active material.

The technical field of the invention can generally be defined as the field of electrodes used in electrochemical systems with non-aqueous, organic electrolyte, and more particularly as the field of rechargeable storage batteries (accumulators) (secondary batteries), with organic electrolyte such as lithium storage batteries, accumulators, batteries, and more particularly lithium ion storage batteries, accumulators, batteries.

### STATE OF THE PRIOR ART

The growing market for portable equipment has allowed the emergence of lithium storage batteries (accumulators), batteries, technology; the specifications for equipment using these storage batteries (accumulators), batteries, have subsequently become increasingly more demanding. Such equipment requires ever more energy and length of operating time together with the desire for a reduction in the volume and weight of storage batteries.

Lithium technology offers improved characteristics compared with other current technologies. The element lithium is the most lightweight metal with the strongest reducing power, and electrochemical systems using lithium technology can reach voltages of 4V as compared with 1.5 V for the other systems.

Lithium ion batteries offer an energy density by mass of 200 Wh/kg as against 100 Wh/kg for NiMH technology, 30 Wh/kg for lead, and 50 Wh/kg for NiCd.

However, current materials, in particular active materials for electrodes, have reached their limits in terms of performance.

These active materials for electrode are composed of an electrochemically active material which constitutes a receiver structure into which and from which cations e.g. lithium cations insert and extract themselves during cycling. The most frequently used active material for a negative electrode in lithium ion storage batteries is graphite carbon, but its reversible capability is low and it shows irreversible capacity loss <<ICL>>.

With respect to active materials for negative electrodes in Li/ion technology, one possible manner of improving performance is to replace graphite by another material having better capacity, such as tin or silicon.

With a theoretical capacity estimated at 3579 mAh/g (for Si→Li_{3,75}Si), silicon offers a desirable alternative to carbon. Nonetheless, this material has one major drawback preventing the use thereof. Indeed, the volume expansion of silicon particles of about 300% when charging (Li-ion system) leads to particle cracking and detachment of the particles from the current collector.

To provide a material capable of maintaining the integrity of the electrode after repeated charging-discharging cycles, and to overcome the inherent problems of silicon, much research over the last few years has focused on composites in which silicon is dispersed in a matrix, and in particular has focused on silicon/carbon composites.

In the literature, various methods such as energetic milling, chemical vapour deposition (CVD) have been considered to prepare a silicon carbon composite. Energetic milling consists of mixing particles of silicon and carbon under the mechanical action of milling balls. Regarding chemical vapour deposition (CVD), silane (SiH₄) is generally used as the precursor gas. The carbon to be coated is placed inside the oven chamber. When the gas passes through the heated chamber, it breaks down into nanometric silicon particles on the surface of the carbon.

Si/C composites have better cyclability than pure silicon, but show a drop in capacity after a certain number of charging-discharging cycles. This can be accounted for by the change in microstructure of silicon during cycling, since the silicon particles swell until they burst and detach themselves from the electrode. The contact between the silicon and carbon is insufficiently close to allow the carbon to offset the volume changes of silicon.

Among the documents describing the preparation of silicon/carbon composite materials intended to remedy the above-described disadvantages, mention may especially be made of the documents by ZHANG et al. [1], LIU et al. [2], and CHEN et al. [3].

The document by ZHANG et al. [1] describes the preparation of composite materials based on disordered carbon and nanometric silicon by mechanical milling followed by pyrolysis. More precisely, specific quantities of silicon powder and poly(vinyl chloride) (PVC) or poly(paraphenylene) (PPP) are mechanically milled in a ball mill for 24 hours to yield Si-polymer composites in which the Si particles are coated with the polymer.

These Si-polymer composites are then heated to 650° C., 800° C. and 900° C. for two hours under a flow of argon, whereby the final composite material based on nanometric silicon and disordered carbon is obtained.

Composite anodes for lithium ion storage batteries (accumulators), batteries are then prepared by applying a suspension containing 80% silicon/carbon composite material, 10% carbon black as electronically conductive additive, and 10% polyvinylidene fluoride (PVDF) as binder in N-methylpyrrolidone (NMP) onto both sides of a copper web.

On account of the milling used to prepare the Si/polymer composite material, loss of contact occurs between carbon and silicon.

The composite Si/C material prepared in this document [1] has a highly irregular morphology and an uneven particle size on account of this milling.

The document by LIU et al. [2] describes a method to prepare a silicon/disordered carbon composite material for the anode of a lithium ion storage battery (accumulator), in which PVC and silicon particles of a size lower than 1 micron are mixed homogeneously, then the mixture is pyrolyzed a first time at 900° C. in an argon atmosphere, and cooled. The resulting product is then subjected to high energy mechanical milling (<<HEMM>>), in a closed chamber under argon. The samples thus obtained are again mixed with PVC and the mixture is pyrolyzed a second time under the same conditions as for the first pyrolysis, and the samples thus pyrolyzed are milled and sieved.

The material thus prepared shows stable capacity at 900 mAh/g after 40 cycles and a faradic yield at the first cycle of 82%.

In this document [2], another composite is prepared by milling graphite and silicon using an <<HEMM>> process then the product obtained is mixed with PVC and pyrolysis is conducted under the same conditions as those already described above.

Due to the high energy milling used in document [2] to prepare the composites, loss of contact again occurs between carbon and silicon, and the materials prepared in document [2] show again a very irregular morphology and an uneven particle size on account of this milling.

To overcome some disadvantages of the processes described above, especially in documents [1] and [2], the document by CHEN et al. [3] proposes preparing spherical, nanostructured Si/C composites of small (fine) particle size by using a spray drying technique followed by heat treatment, whereby composites are obtained in which nanometric silicon particles and fine particles of graphite are homogeneously trapped, embedded in a carbon matrix produced by pyrolysis of a phenol-formaldehyde (<<PF>>) resin.

More precisely, the resin is first dissolved in ethanol, then nanometric silicon powder and fine graphite powder are added to the PF resin solution whereby a suspension containing particles of graphite and silicon is obtained. This suspension is then subjected to a spray-drying operation after which spherical or spheroid particles of Si/PF precursor are obtained which are heated at 1000° C. for 2 hours, whereby a Si/C composite is obtained. This Si/C composite may then be dispersed in a PF solution and again subjected to the same steps of spray-drying and pyrolysis whereby a carbon-coated Si/C composite is obtained.

The capacity of the composites of this document [3] increases over the first cycles up to 635 mAh/g to reach 500 mAh/g after 40 cycles.

Having regard to the material used, the theoretical capacity of the composites of document [3] should be 1363 mAh/g, yet it has been seen that the practical capacity is 635 mAh/g, i.e. only 50% of the theoretical capacity.

The electrochemical performance of the composite material prepared in document [3] is therefore poor and still insufficient, notably in terms of capacity and yield.

Taking the forgoing into account, there is therefore a need for a process to prepare a composite Silicon Carbon Si/C material which, when used as an active material for an electrode, especially for a negative electrode e.g. an electrode for a lithium ion storage battery (accumulator) and in particular a negative electrode for a lithium ion storage battery, shows an excellent mechanical resistance upon cycling and excellent electrochemical performance in terms of capacity, capacity stability and yield.

There is further a need for such a process which is simple, reliable and of reasonable cost.

The goal of the present invention is to provide a process for preparing a composite silicon-carbon material which inter alia meets the afore-mentioned needs.

It is a further goal of the invention to provide a process for preparing a composite silicon/carbon material which does not have the shortcomings, drawbacks, defects, limitations and disadvantages of prior art processes, and which solves the problems of prior art processes.

### DISCLOSURE OF THE INVENTION

This goal, and others, are achieved according to the invention by a process for preparing a composite silicon/carbon material composed of (consisting in) carbon-coated silicon particles, wherein the following successive steps are performed:

a) silicon particles are mixed with a solution of an oxygen-free polymer in a solvent, whereby a dispersion of silicon particles in the polymer solution is obtained;

b) the dispersion obtained in step a) is subjected to a spray-drying operation, whereby a composite silicon/polymer material composed of (consisting in) silicon particles coated with the polymer;

c) the material obtained in step b) is pyrolyzed, whereby the composite silicon/carbon material composed of carbon-coated silicon particles is obtained.

The process according to the invention comprises a specific sequence of specific steps which has never been described in the prior art.

In particular, the process of the invention sets itself fundamentally apart from prior art processes, and notably from prior art processes using a spray-drying technique, in that the polymer used is a polymer with no oxygen atom, is devoid of oxygen and does not contain any oxygen.

Unexpectedly, by using a polymer without any oxygen atom in a process involving spray-drying and pyrolysis to prepare a composite Si/C material, the performance of a lithium storage battery (accumulator), battery, comprising this material as electrochemically active material for an electrode, notably for a negative electrode, is improved as compared with a storage battery (accumulator) comprising as active material for an electrode a Si/C composite material prepared by spray-drying and pyrolysis but from a polymer or resin comprising oxygen.

Evidently, the performance of a lithium ion storage battery (accumulator), battery, which, as active material for an electrode and in particular for a negative electrode, comprises the composite material prepared using the process of the invention, is also largely improved compared with a storage battery whose active material for an electrode, notably for a negative electrode, consists of a composite Si/C material prepared using a process which does not involve spray-drying such as milling or chemical vapour deposition (CVD).

In other words, the process of the invention firstly has all the advantages inherent in the spray-drying method in that it provides control over the particle size and morphology of the polymer/Si composite before pyrolysis, ensuring subsequent strong contact at the silicon-carbon interface after pyrolysis, and secondly it does not have the disadvantages related to the use of a polymer containing oxygen.

The process according to the invention does not have the disadvantages of prior art processes and provides a solution to prior art processes.

Advantageously, the polymer can be chosen from among polystyrene (PS), poly(vinyl chloride) (PVC), polyethylene, polyacrylonitrile (PAN), and polyparaphenylene (PPP).

Advantageously, the solvent may be chosen from among halogenated alkanes such as dichloromethane; ketones such as acetone and 2-butanone; tetrahydrofuran (THF); N-methylpyrrolidone (NMP); acetonitrile; dimethylformamide (DMF); dimethylsulfoxide (DMSO); and mixtures thereof.

Preferably, the polymer may be polystyrene, and the solvent may be 2-butanone.

Advantageously, the concentration of the polymer in the solution may be 10 g/litre of solvent to 200 g/litre of solvent.

The silicon particles may be micrometric particles i.e. particles whose size as defined by their largest dimension (namely the diameter for example for spherical particles) is 1 to 200 micrometres, preferably 1 to 45 micrometres.

Or the silicon particles may be nanometric particles i.e. particles whose size as defined by their largest dimension (i.e. the diameter for example for spherical particles) is 5 to 1000 nanometres, preferably 5 to 100 nanometres.

The nanometric silicon particles may notably be silicon particles synthesized by reducing SiCl₄ under a controlled atmosphere, i.e. preferably under argon.

Advantageously, and notably if the nanometric silicon particles are silicon particles synthesized by reducing SiCl₄ under a controlled atmosphere, step a) is then conducted under a controlled atmosphere, preferably under argon.

Advantageously, the concentration of the silicon particles in the dispersion may be 0.1 to 50 g/L.

Generally, the silicon particles coated with the polymer are of spherical type with a diameter of 1 micrometre to 20 micrometres for example.

More generally, the material is globally a spherical or spheroid composite material containing particles of silicon trapped, embedded, in a polymer matrix.

Advantageously, a dispersant may also be added during step a).

In general, during step b) the dispersion is sprayed in droplets using a nozzle brought to a temperature of 20° C. to 220° C., preferably 60° C. to 110° C.

Advantageously, step c) is conducted at a temperature of 600° C. to 1100° C., preferably 800° C. to 900° C.

Advantageously, step c) can be performed under a controlled atmosphere such as an argon atmosphere, or an argon and hydrogen atmosphere.

In general, the carbon-coated silicon particles form clusters and are of nanometric size.

The invention further concerns the composite silicon/carbon material obtainable by the process such as described in the foregoing.

This composite material notably finds application as electrochemically active material for an electrode in any electrochemical system. Preferably, this electrode is a negative electrode.

The invention further concerns an electrode, preferably a negative electrode, of an electrochemical system such as a rechargeable electrochemical storage battery (electrochemical secondary battery) with non-aqueous electrolyte, comprising the composite silicon/carbon material prepared according to the process of the invention as electrochemically active material for an electrode, preferably for a negative electrode.

Generally, said electrode, preferably a negative electrode, further comprises a binder, optionally one or more electronic conductive additives, and a current collector.

The invention will now be described more precisely in the following description, which is non-limiting and given by way of illustration, with reference to the appended drawings in which:

### BRIEF DESCRIPTION OF THE DRAWINGS

FIG. 1 is a photograph showing a spray-drying equipment to implement the process of the invention;

FIG. 2 is a photograph showing the spray nozzle fitted to the equipment illustrated in FIG. 1, and the mist of the dispersion of silicon particles in a polymer solution emitted by this nozzle;

FIG. 3 is a vertical-section schematic view of a storage battery, accumulator, in the form of a button battery, cell, comprising a positive electrode or negative electrode for example to be tested according to the invention (examples 2 to 4);

FIG. 4 is an image taken under a scanning electron microscope (<<SEM>>) of the composite Si/polystyrene material obtained in Example 1 after the spray-drying operation. The scale indicated in the figure represents 10 μm;

FIG. 5 is an image taken under a scanning electron microscope (<<MEB>>) of the composite Si/C material obtained in Example 1 after the pyrolysis operation at 900° C. The scale indicated in the figure represents 5 μm;

FIG. 6 is a graph giving the charge capacity (in mAh/g—curve with solid line) and discharge capacity (curve with dotted line) in relation to the number of cycles during the test following a first cycling protocol (Example 2) of a button battery, cell whose positive electrode comprises as electrode active material a composite material prepared in Example 1 following the process of the invention;

FIG. 7 is a graph giving the discharge capacity (in mAh/g) in relation to the number of cycles during the test according to a second cycling protocol (Example 3) of a button battery, cell whose positive electrode comprises as electrode active material a composite material prepared in Example 1 using the process of the invention;

FIG. 8 is a graph giving the discharge capacity (en mAh/g) in relation to the number of cycles during the test following the first cycling protocol (Example 4) of a button battery, cell whose positive electrode comprises as electrode active material a composite material prepared in Example 1 using the process of the invention, pyrolysis being conducted at 800° C. (curve with solid line) or at 900° C. (curve with dotted line).

### DETAILED DESCRIPTION OF PARTICULAR EMBODIMENTS

In general, this description refers more particularly to an embodiment in which the composite material prepared using the process of the invention is the active material of a positive or negative electrode of a lithium ion rechargeable storage battery (lithium ion secondary battery), but the following description can evidently and if necessary be extended and adapted to any application and embodiment of the composite material prepared in accordance with the process of the invention.

In the first step of the process according to the invention, silicon particles are mixed with a solution of a polymer devoid of any oxygen atom in a solvent, whereby a dispersion of silicon particles in the polymer solution is obtained.

According to the invention, the polymer is a polymer without any oxygen atom, not containing oxygen, devoid of oxygen atoms.

This polymer can notably be chosen from among polystyrene (PS), poly(vinyl chloride) (PVC), polyethylene, polyacrylonitrile (PAN), and polyparaphenylene (PPP).

Amongst these polymers, the preferred polymer is polystyrene (PS) due to its lack of toxicity, its low cost and the fact that it does not release any chlorine.

The solvent of the polymer solution can be chosen from among a wide variety of solvents. Thus, this solvent can be chosen from among halogenated alkanes such as dichloromethane; ketones such as acetone and 2-butanone; tetrahydrofuran(THF); N-methylpyrrolidone (NMP); acetonitrile; dimethylformamide (DMF); dimethylsulfoxide (DMSO); and mixtures thereof.

For each polymer, the man skilled in the art can easily determine the solvent to be chosen in order to obtain full dissolution of the polymer.

As an example, Table 1 below indicates the solvents in which polyvinyl chloride (PVC), polyparaphenylene (PPP), polyacrylonitrile (PAN) and polystyrene (PS) are soluble to the proportion of 1 to 50 mass %, preferably 1 to 20 mass %. The solubility of the polymer in the solvent is indicated by a cross (X).

TABLE 1

| | | | | | Boiling | | Nozzle |
|---|---|---|---|---|---|---|---|
| | PCV | PPP | PAN | PS | temperature | | temperature |
| dichloromethane | X | X | | | 40° | C. | 20-70 |
| THF | X | | | X | 65-67° | C. | 45-95 |
| 2-butanone | X | | | X | 80° | C. | 60-110 |
| NMP | X | | X | X | 202° | C. | 180-220 |
| acetonitrile | | | | | 81-82° | C. | 60-110 |
| acetone | | | | | 55° | C. | 35-85 |
| DMF | X | | X | | 153° | C. | 130-183 |
| DMSO | X | | X | | 189° | C. | 165-210 |

It is noted that PPP is highly resistant to chemical attack and that it can only be solubilised by dichloromethane.

Preferably, the polymer is polystyrene, and the solvent is 2-butanone.

The placing of the polymer in solution in the solvent is generally conducted under stirring, for example for a period that is sufficient for full dissolution of the polymer in the solvent.

The concentration of the polymer in the solution may be as high as the solubility limit of the polymer in the chosen solvent, and for example it may range from 10 g/litre of solvent to 200 g/litre of solvent.

To this solution of polymer in the solvent, particles of silicon are added which are generally in the form of a powder.

The silicon particles may be micrometric particles i.e. particles whose size as defined by their largest dimension (namely the diameter for spherical particles) is 1 to 200 micrometres, preferably 1 to 45 micrometres.

Or else, the silicon particles may be nanometric particles, i.e. particles whose size as defined by their largest dimension (i.e. the diameter for example for spherical particles) is 5 to 1000 nanometres, and preferably 5 to 100 nanometres.

The micrometric or nanometric silicon particles may be commercially available nanometric or micrometric particles.

It is to be noted, however, that silicon has a layer of native oxide and that commercially available silicon is therefore slightly oxidized. Yet, silicon oxide SiO₂ does not have good electrochemical performance and is preferably to be avoided. To avoid silicon oxide, it can therefore be envisaged to use prepared nanometric silicon that is synthesized by reducing SiCl₄ under a controlled atmosphere such as an argon atmosphere, in a glove box for example.

In this respect, reference may be made to the document of Y. KWON et al. [4].

In particular, when silicon synthesized in this manner is used, it is preferable to conduct step a) under a controlled atmosphere such as an argon atmosphere, for example by mixing the silicon particles in the polymeric solution in a glove box.

The mixing of the silicon particles with the solution of the polymer free of any oxygen atom is generally conducted under stirring, for example using a magnetic stirrer, and the mixture is generally homogenized by means of ultrasound, whereby a homogeneous dispersion of silicon particles in the polymer solution is obtained.

The concentration of silicon particles in the dispersion may range from 0.1 to 50 g/L.

In addition to the silicon particles, it is possible to add a dispersant to the polymer solution during step a), to avoid the aggregation, agglomeration, of the silicon particles when mixing the polymer/silicon mixture before spray drying.

This dispersant, for example, may be CarboxyMethylCellulose (CMC) or, more generally, an anionic surfactant such as sodium dodecyl sulphate; or a cationic surfactant such as cetyl trimethyl ammonium bromide; or a neutral surfactant, such as polyethylene glycol octyphenyl ether.

The dispersant is generally used in a proportion of 0.1 to 100 mmol/g of material to be dispersed.

According to the process of the invention, this dispersion is subjected to a spray-drying operation which allows encapsulation of the silicon particles by the polymer, the polymer then being pyrolyzed.

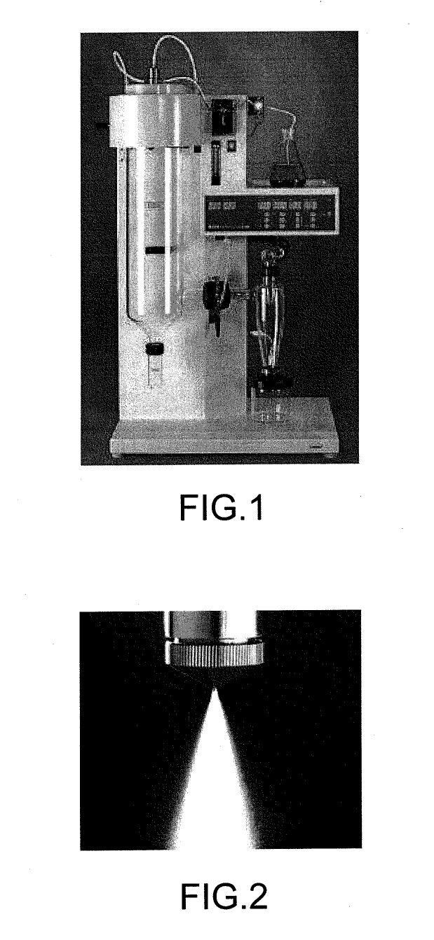

This spray-drying operation may be conducted using a conventional, common, spray-dying apparatus, technique that is routinely, commonly used in the pharmaceutical and agri-food fields such as the one illustrated in FIG. 1.

The dispersion is fed at the top of a spray drier, a spray tower, passes through a nozzle (see FIG. 2) which atomizes, sprays the dispersion in droplets.

The temperature of the nozzle is generally regulated, controlled, in relation to the boiling temperature (Tb) of the solvent in the dispersion. The maximum temperature of the nozzle or T_{nozzlemax} is preferably equal to about Tb +30° C., whilst the minimum temperature of the nozzle or T_{nozzlemin} is preferably equal to about Tb −20° C.

Table 1 above gives the temperature ranges of the nozzle for different solvents of the dispersion, together with the boiling temperature of these solvents.

The nozzle may generally be brought to a temperature of 220° C., preferably 60° C. to 110° C.

If the system is placed under pressure, it is then possible to lower the temperature of the nozzle.

The droplets thus formed are then dried in a flow of hot gas, hot air for example, which causes the solvent to evaporate and the droplets then fall onto the inner walls of the apparatus.

The composite silicon/polymer material, generally in powder form, is usually collected using a cyclone.

The solvent-containing gas, such as air, is generally cooled in a heat exchanger, then condensed in a refrigeration unit and finally collected in a vessel provided for this purpose. The gas, such as air, is generally re-injected into the sprayer.

With spray-drying it is possible to obtain a polymer/silicon composite whose morphology is generally spherical or spheroid, and of controlled particle size.

Generally, the composite silicon/polymer material contains particles of silicon trapped, embedded, in a polymer matrix, and is generally in particle form.

In general, the silicon particles coated with the polymer obtained after the spray-drying operation are spherical or spheroid and generally have a diameter of 1 micrometre to 20 micrometres if the silica particles are of nanometric size, as illustrated in FIG. 5.

The particles generally form a powder.

The controlled morphology and particle size mentioned above ensure that, after pyrolysis, a strong interface is maintained between the silicon and carbon.

The composite silicon/polymer material generally consisting of a powder formed by silicon particles coated with the polymer is then, in accordance with the process of the invention, subjected to pyrolysis heat treatment at a temperature generally of 600° C. to 1100° C.

This treatment is generally conducted under a controlled atmosphere, namely a non-oxidizing atmosphere such as an argon atmosphere, or an atmosphere of argon and hydrogen, to minimize oxidization.

Indeed, to avoid or minimize possible contacts between the silicon and an oxygen source, it would be preferable to conduct the entire process under a controlled, non-oxidizing atmosphere, free of oxygen, such as an argon atmosphere.

Pyrolysis can be performed using equipment such as a tubular furnace, under a flow of argon.

The final composite Si/C material obtained with the process of the invention is in the form of silicon particles coated with carbon for example (see FIG. 5), more exactly coated with a carbon matrix. These particles generally form clusters or aggregates of Si and C and are generally of nanometric size.

The composite Si/C material may be in the form of particles for example, which generally form a powder.

The composite material thus prepared according to the invention may be used as electrochemically active material in any electrochemical system.

More precisely, the composite material prepared according to the invention may especially be used as electrochemically active material for a positive or negative electrode in any electrochemical system with non-aqueous electrolyte.

This positive or negative electrode, in addition to the electrochemically active material for positive or negative electrode such as defined above, also comprises a binder which is generally an organic polymer, optionally one or more electronic conductive additive(s) and a current collector.

The organic polymer can be chosen from among polytetrafluoroethylene (PTFE), poly(vinylidene fluoride) (PVDF), the co-polymer PVDF-HFP (hexafluoride propylene); and the elastomers such as CMC-SBR (carboxymethylcellulose-styrene butadiene rubber).

The optional electronic conductive additive may be chosen from among metal particles such as particles of Ag, graphite, carbon black, carbon fibres, carbon nanowires, carbon nanotubes, electronic conductive polymers and mixtures thereof.

The current collector is generally in the form of a copper, nickel or aluminium foil.

The electrode generally comprises 70 to 94% by mass of electrochemically active material, 1 to 20% by mass, preferably 1 to 10% by mass of binder, and optionally 1 to 15% by mass of electronical conductive additive(s).

Such an electrode can be prepared as is conventional by forming a slurry, suspension, paste or ink with the electrochemically active material, the binder and optionally the conductive additive(s) and a solvent, by depositing, coating or printing this slurry, suspension, paste or ink onto a current collector, drying the deposited ink, paste or suspension, slurry, and by calendering, pressing the deposited, dried ink or paste and the current collector.

It is to be noted that, according an additional advantage of the composite Si/C material according to the invention, its use as electrode does not require major mechanical milling since mere grinding in a mortar, which is no way affects the properties of the composite, is sufficient to break down any aggregates, agglomerates, which might be present.

The ink, paste or suspension, slurry, can be applied using any suitable method such as coating, depositing, surface application, photogravure, flexography, offset.

The electrochemical system may notably be a rechargeable electrochemical storage battery, accumulator (electrochemical secondary battery) with non-aqueous electrolyte, such as a lithium battery or storage battery, accumulator, and more particularly a lithium ion storage battery, accumulator, battery which, in addition to the positive or negative electrode such as defined above which comprises the composite material prepared according to the invention as electrochemically active material, further comprises a negative or positive electrode which does not contain the composite material of the invention, and a non-aqueous electrolyte.

The negative or positive electrode, which does not contain the composite material of the invention as electrochemically active material, comprises an electrochemically active material different from the composite material of the invention, a binder, optionally one or more electronic conductive additives, and a current collector.

The binder and the optional electronic additive(s) have already been described in the foregoing.

The electrochemically active material for the negative or positive electrode which does not contain the composite material of the invention as electrochemically active material, may be chosen from among all materials known to those skilled in the art.

Therefore, when the composite material of the invention is the electrochemically active material of the positive electrode, then the electrochemically active material of the negative electrode can be chosen from among lithium and any other material known to the man skilled in the art in this technical field.

When the electrochemically active material of the negative electrode is formed of the material according to the invention, the electrochemically active material of the positive electrode may be made of any material known to and adaptable by the man skilled in the art.

The electrolyte may be solid or liquid.

If the electrolyte is liquid, it is composed for example of a solution of at least one conductive salt such as a lithium salt in an organic solvent and/or an ionic liquid.

If the electrolyte is solid, it comprises a polymer material and a lithium salt.

The lithium salt can be chosen for example from among LiAsF₆, LiClO₄, LiBF₄, LiPF₆, LiBOB, LiODBF, LiB(C₆H₅), LiCF₃SO₃, LiN(CF₃SO₂)₂(LiTFSI), LiC(CF₃SO₂)₃(LiTFSM).

The organic solvent is preferably a solvent compatible with the constituents of the electrodes, it is relatively little volatile, aprotic and relatively polar. As examples, mention may be made of ethers, esters and mixtures thereof.

The ethers are notably chosen from among linear carbonates such as dimethyl carbonate (DMC), diethyl carbonate (DEC), ethylmethyl carbonate (EMC), dipropyl carbonate (DPC), the cyclic carbonates such as propylene carbonate (PC), ethylene carbonate (EC), and butylene carbonate; alkyl esters such as the formiates, acetates, propionates and butyrates; gamma butyrolactone, triglyme, tetraglyme, lactone, dimethylsulphoxide, dioxolane, sulpholane and mixtures thereof. The solvents are preferably mixtures including EC/DMC, EC/DEC, EC/DPC and EC/DMC.

The storage battery may notably be in the form of a button cell.

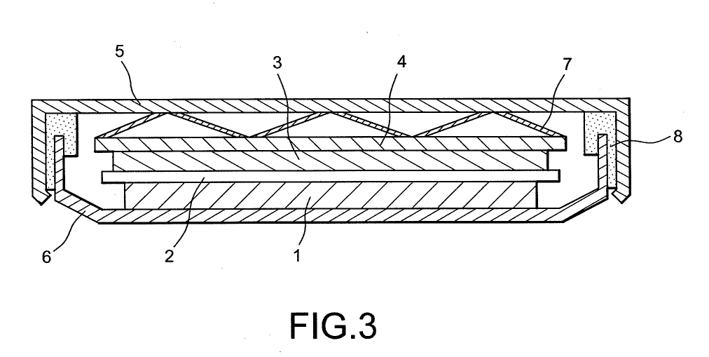

The different parts of a button battery, cell made of 316 L stainless steel are described in FIG. 3.

These parts are the following:
the upper (5) and lower (6) portions of the stainless steel casing,
the polypropylene gasket (8),
the stainless steel, shims, skids, retainers (4), which are used for example both for cutting the lithium metal and subsequently for ensuring good contact between the current collectors and the outer portions of the battery,
a spring (7), ensuring contact between all the parts,
a microporous separator (2) impregnated with electrolyte,
electrodes (1) (3).

The invention will now be described with reference to the following examples given solely for illustration and which are non-limiting.

### EXAMPLE 1

In this example, a composite silicon/carbon material is prepared according to the process of the invention.

Under stirring, polystyrene (PS) is placed in solution in 2-butanone, at concentrations ranging from 200 g/litre of solvent to 10 g/litre of solvent. The preferred solution is 60 g/litre.

Each time, it must be waited until the polystyrene is fully dissolved in the solvent, and a solution of polystyrene in 2-butanone is therefore obtained.

In each of the polystyrene solutions, silicon is added in powder form with a nanoparticle size of less than 100 nm, supplied by Aldrich®, and the mixture is homogenized by ultrasounds under magnetic stirring. In this manner, dispersions of silicon particles in the polystyrene solutions are obtained, for example a dispersion of 60 g PS per litre of solvent and 3 g of Si per litre of solvent.

Each of these dispersions is then added to a spray-drying device, namely a <<Mini spray dryer B290>> apparatus obtained from Buchi®. Each of the dispersions passes through the nozzle of the spray-drying device with a nozzle temperature of between 60° C. (Tb_{nozzlemin}) and 110° C. (T_{nozzlemax}). The solvent therefore evaporates, and a powder composed of silicon particles coated with polystyrene, or rather composed of a polymer matrix with Si inclusions, is collected in the spray of the spray-drying apparatus.

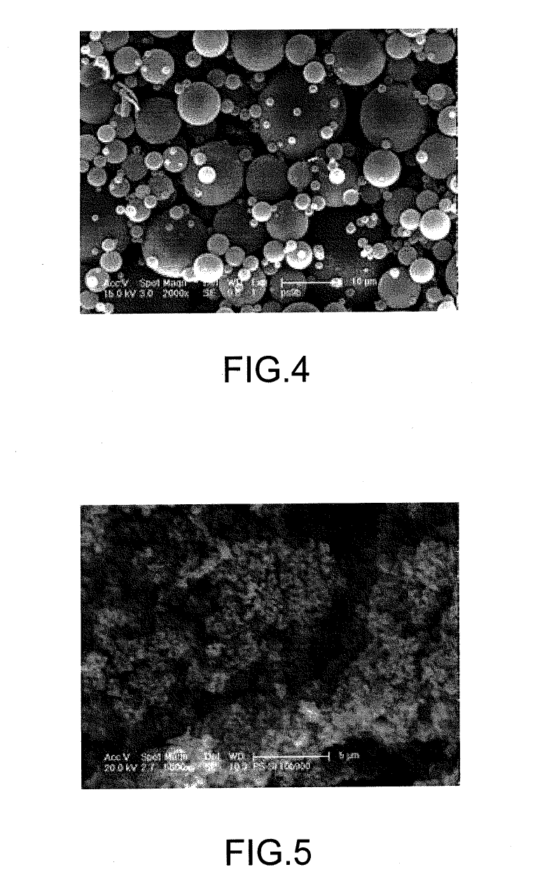

As can be seen on the SEM image in FIG. 4, the particles of composite Si/PS material obtained after spray-drying a dispersion containing 3 g of Si per litre of solvent and 60 g of PS per litre of solvent, are spherical with a diameter of between 1 micrometre and 20 micrometres for an initial diameter of the Si powder of 5 to 100 nm.

The more the PS concentration in the dispersion increases, the more the size of the particles of composite material increases.

This powder of silicon particles coated with polystyrene (Si/PS composite) is then pyrolized in a tubular furnace at different constant temperatures between 600° C. and 1100° C., for example at 800° C. and 900° C. under a controlled atmosphere of argon and hydrogen to minimize oxidization thereof.

As can be seen in the SEM image of FIG. 5, the powder of Si/C composite obtained after pyrolysis at 900° C. of the powder in FIG. 4 has a nanometric structure.

The polystyrene after pyrolysis at 900° C., loses about 95% of its mass.

The particles of this powder are silica particles coated with a carbon matrix.

The composite Si/C materials prepared in Example 1 were then tested as active material for a positive electrode in lithium metal batteries (half-cell test) of <<button cell>> type. These tests are the subject of Examples 2 to 4.

Each button, cell, battery is assembled while scrupulously observing the same procedure. Starting from the bottom of the battery cell casing, as can be seen in FIG. 3, the following are stacked:
a lithium negative electrode (16 mm in diameter, 130 micrometres thick) (1) deposited on a nickel disc acting as current collector, but it is also possible to use any other active material for the negative electrode, notably chosen from among conventional active materials used in this technical field for a negative electrode in non-aqueous medium;
200 μL of liquid electrolyte based on LPF₆ salt to the proportion of 1 mol/L in solution in a mixture of ethylene carbonate and dimethyl carbonate, but any other non-aqueous liquid electrolyte known in this technical field could be used;
the electrolyte impregnates a separator which is a microporous membrane made of polyolefin, more precisely a microporous membrane made of Celgard® polypropylene (2) Ø 16.5 mm;
a positive electrode (3) consisting in a disc 14 mm in diameter, taken from a composite film of thickness 25 μm comprising the Si/C composite described above and prepared in Example 1 (80% by mass), carbon black (10% by mass) as conductive material and polyvinylidene hexafluoride (10% by weight) as binder, the whole being deposited on a copper current collector (foil 18 μm thick);
a disc, shim, skid or retainer in stainless steel (4),
a cover, lid, in stainless steel (5) and a bottom part in stainless steel (6),
a stainless steel spring (7) and a polypropylene gasket joint (8).

The stainless steel casing is then closed with a crimping machine, making it fully airtight, airproof. To check that the batteries are operational, they are checked by measuring the floating voltage.

Owing to the strong reactivity of lithium and its salts to oxygen and water, the setting up of a cell button battery is carried out in a glove box. This box is held under a slight over-pressure under an atmosphere of anhydrous argon. Sensors are used for continual monitoring of the concentration of oxygen and water. Typically, these concentrations must remain lower than one ppm.

The composite Si/C materials prepared following the process of the invention in Example 1, and mounted in button batteries conforming to the procedure described above, are subjected to cycling i.e. charging and discharging operations at different operating conditions, at constant current, for a determined number of cycles, to evaluate the practical capacity of the battery.

For example, a battery charging at a rate of C/20 is a battery subjected to a constant current for 20 hours for the purpose of recovering all its capacity C. The value of the current is equal to the capacity C divided by the number of charging hours, namely 20 hours in this case.

### EXAMPLE 2

In this example, the electrode active material comprises a composite Si/C material prepared according to Example 1 above, by pyrolysis of a Si/PS composite (FIG. 4) at a temperature of 900° C.

A test is conducted following a first cycling procedure:
20 C/10 charging-discharging cycles (charging in 10 hours, discharging in 10 hours),
10 C/5 charging-discharging cycles,
5 C/2 charging-discharging cycles,
5 cycles at C,
5 cycles at 2C,
5 C/5 discharging-charging cycles.

The results of this test are illustrated in FIG. 7.

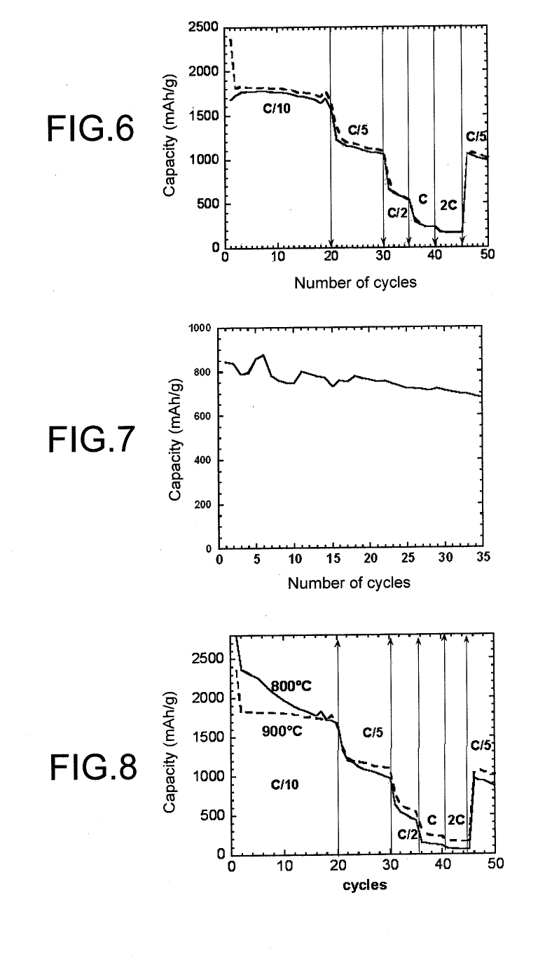

It is ascertained that at 20° C., under C/10 test conditions (C equivalent to 1300 mAh/g), this system delivers a stable capacity of about 1700 mAh/g (FIG. 6).

After successive C/5, C/2, C, 2C cycling operations, the system recovers a capacity of the order of 1000 mAh/g.

### EXAMPLE 3

In this example, a battery comprising the same active electrode material as in Example 2, is subjected to a test following a second cycling procedure comprising 35 discharging-charging cycles at C/2.5. It is ascertained that the capacity is in the region of 800 mAh/g with a very low drop in capacity, as is illustrated in FIG. 7.

### EXAMPLE 4

In this example, the electrochemical performance of an active electrode material comprising a composite Si/C material prepared in accordance with Example 1 by pyrolysis of a Si/PS composite (FIG. 4) at a temperature of 900° C., is compared with the performance of an active electrode material comprising a composite Si/C material prepared in accordance with Example 1 above by pyrolysis of a Si/PS composite (FIG. 4) at a temperature of 800°.

These two materials were tested following the same procedure as the one in Example 2.

The results of these tests are given in FIG. 8.

It is ascertained that the composite material prepared by pyrolysis at 900° C. gives better electrochemical performance. The capacity is stable for the C/10 and C/5 test conditions, contrary to the battery whose electrode active positive material comprises a composite material prepared by pyrolysis at 800° C. The capacity is slightly lower at lower test conditions.

### REFERENCES

[1] X. W. Zhang, P. K. Patil, C. Wang, A. J. Appleby, F. E Little, D. L Cocke, Journal of Power Sources, 125 (2004), 206-213.
[2] Y. Liu, K. Hanai, J. Yang, N. Imanishi, A. Hirano, Y. Takeda, Electrochemical and Solid-State Letters, 7(10), A369-A372 (2004).
[3] L. Chen, X. Xie, B. Wang, K. Wang, J. Xie, Materials Science and Engineering, B: Solid-State Materials for Advanced Technology, 131(1-3), 186-190, 2006.
[4] Y. Kwon, G. S. Park, J. Cho, Electrochimica Acta, 52(2007), 4663-4668.

1. A method of preparing a composite silicon/carbon material formed of carbon-coated silicon particles, the method comprising:
mixing silicon particles with a solution of an oxygen-free polymer in a solvent, whereby a dispersion of silicon particles in the polymer solution is obtained;
subjecting the obtained dispersion of silicon particles to a spray-drying process, whereby a composite silicon/polymer material comprising silicon particles coated with the polymer is obtained;
pyrolyzing the composite silicon/polymer material, whereby a composite silicon/carbon material composed of carbon-coated silicon particles is obtained.

2. The method according to claim 1, wherein the polymer is selected from the group consisting of polystyrene (PS), poly(vinyl chloride) (PVC), polyethylene, polyacrylonitrile (PAN), and polyparaphenylene (PPP).

3. The method according to claim 1, wherein the solvent is chosen from the group consisting of halogenated alkanes; ketones; tetrahydrofuran (THF); N-methylpyrrolidone (NMP); acetonitrile; dimethylformamide (DMF); dimethylsulfoxide (DMSO); and mixtures thereof.

4. The method according to claim 1, wherein the polymer is polystyrene, and the solvent is 2-butanone.

5. The method according to claim 1, wherein the concentration of polymer in the solution is about 10 g/litre of solvent to about 200 g/litre of solvent.

6. The method according to claim 1, wherein the silicon particles are micrometric particles.

7. The method according to claim 2, wherein the silicon particles are nanometric particles.

8. The method according to claim 7, wherein the silicon particles are silicon particles synthesized by reducing SiCl₄ under a controlled atmosphere.

9. The method according to claim 8, wherein mixing the silicon particles is carried out under a controlled atmosphere.

10. The method according to claim 1, wherein the concentration of the silicon particles is within the dispersion ranges from about 0.1 to about 50 g/L.

11. The method according to claim 1, wherein the silicon particles coated with the polymer are spherical and have a diameter of about 1 micrometre to about 20 micrometres.

12. The method according to claim 1, wherein a dispersant is further added during mixing of the silicon particles.

13. The method according to claim 1, wherein subjecting the obtained dispersion of silicon particles to a spray-drying process comprises spraying in droplets by a nozzle brought to a temperature of about 20° C. to about 220° C.

14. The method according to claim 1, wherein pyrolyzing the composite silicon/polymer material is carried out at a temperature of about 600° C. to about 1100° C.

15. The method according to claim 1, wherein pyrolyzing the composite silicon/polymer material is carried out under a controlled atmosphere.

16. A silicon/carbon composite material obtainable by the method according to claim 1.

17. An electrode of an electrochemical system with non-aqueous electrolyte, such as an electrochemical, rechargeable storage battery with non-aqueous electrolyte which, as electrochemically active material, comprises the composite silicon/carbon material according to claim 16.

18. The method according to claim 3, wherein the halogenated alkanes comprise dichloromethane, and wherein the ketones are selected from the group consisting of acetone and 2-butanone.

19. The method according to claim 1, wherein the silicon particles are synthesized under a controlled atmosphere of argon.

20. The method according to claim 1, wherein the subjecting the obtained dispersion to a spray-drying process comprises spraying in droplets by a nozzle brought to a temperature of about 60° C. to about 110° C.

21. The method according to claim 1, wherein pyrolyzing the composite silicon/polymer material is carried out at a temperature of about 800° C. to about 900° C.

22. The method according to claim 1, wherein pyrolyzing the composite silicon/polymer material is carried out under a controlled atmosphere of argon or argon and hydrogen.
